(19) United States
(12) Patent Application Publication
(10) Pub. No.: US 2024/0253147 A1
(43) Pub. Date: Aug. 1, 2024

(54) A Method of Forming a Unitary Metal Piece

(71) Applicant: The M.K. Morse Company, Canton, OH (US)

(72) Inventors: Chandra Sekhar Rakurty, Canton, OH (US); Nithin Rangasamy, Canton, OH (US); Zachary Maurer, Canton, OH (US)

(21) Appl. No.: 18/560,818

(22) PCT Filed: May 16, 2022
(86) PCT No.: PCT/US22/29430

§ 371 Date: Nov. 14, 2023

Related U.S. Application Data
(60) Provisional application No. 63/188,579, filed on May 14, 2021.

(51) Int. Cl. B23K 11/02; B23D 65/00; B23K 37/08; B23K 101/20; B23K 103/04; B24B 57/02

(52) U.S. Cl. CPC B23K 11/02; B23D 65/00; B23K 37/08; B24B 57/02; B23K 2101/20; B23K 2103/04

(57) ABSTRACT

A method of forming a unitary metal piece includes providing first and second generally planar metallic portions. Each portion has generally parallel first and second sides opposite each other. Each portion has an end edge extending between the first and second sides. The first and second ends are proximate one another. The end edges are resistance welded together to form a weld joint and produce weld flash on at least one of the first and second sides of the portions. The weld flash on at least one of the first and second sides is ground, and a fluid is applied to the weld joint during the grinding of the weld flash.

### CROSS-REFERENCE TO RELATED APPLICATIONS

This application claims priority to and the benefit of U.S. Provisional Patent Application 63/188,579, filed 14 May 2021, the contents of which are hereby incorporated by reference in their entirety.

### BACKGROUND

This relates in general to the manufacture and working of metal articles. One known method of joining metal pieces is welding. Welding is the uniting or fusing of two or more separate materials. Some common welding processes include gas welding, arc welding, resistance welding, Energy beam welding, and Solid-state welding. Resistance welding involves the generation of heat by passing current through the resistance caused by the contact between two or more metal surfaces. Typically, small pools of molten metal are formed at the weld area as high current (for example 1000-100,000 A) is passed through the metal. Two well know resistance welding methods are spot welding and seam welding. Such processes typically create weld flash around or about the weld joints. Workpieces joined by resistance welding are often subjected to grinding to remove undesired weld flash.

### SUMMARY

This relates more particularly to methods for forming a unitary metal piece with resistance welding and grinding the weld flash produced while applying a fluid to the weld joint.

One method includes providing first and second generally planar metallic portions. Each portion has generally parallel first and second sides opposite each other. Each portion has an end edge extending between the first and second sides. The first and second ends are proximate one another. The end edges are resistance welded together to form a weld joint and produce weld flash on at least one of the first and second sides of the portions. The weld flash is ground on at least one of the first and second sides, and a fluid is applied to the weld joint during the grinding of the weld flash.

The fluid may be a compressed gas, and the compressed gas may be one of atmospheric air, nitrogen, and carbon dioxide.

The fluid may be a lubricant applied according to Minimum Quantity Lubrication.

The fluid may be a coolant applied according to Minimum Quantity Cooling Lubrication, and the coolant may be a semi-synthetic water-soluble coolant mixed with water.

The fluid may be applied with a consistent flow rate

Prior to grinding, the weld joint may be normalized.

After welding, the welded first and second portions may be annealed.

The first and second portions may be made of a carbon alloy steel.

The first and second portions may be opposite ends of a generally planar blade backer.

There may be a crack or opening disposed between the ends of the first and second portions, and the method may further include placing weldable material in the crack or opening prior to the welding.

There may be a crack or opening disposed between the ends of the first and second portions, and the welding may include additively printing new material in the crack or opening to close the crack or the opening and joining the ends together to form a continuous body and where the weld flash is produced as additively printed weld flash on at least one of the first and second sides.

Another method includes providing first and second generally planar portions of a metallic body having a crack or an opening in a body disposed between first and second ends of the portions. Material is additively printed in the crack or the opening to close the crack or the opening and join the portions together to form a continuous body and produce additively printed weld flash. The additively printed weld flash is ground, while a fluid is applied to the additively printed material during the grinding of the additively printed weld flash.

Another method is a method of forming a band saw blade. This method includes providing a generally planar blade backer having generally parallel right and left sides opposite each other, and having first and second ends opposite each other, and having top and bottom edges opposite each other and extending between the right and left sides and extending between the first and second ends. A plurality of teeth are formed on the top edge of the blade backer. The first and second ends are abutted and resistance welded together to form a weld joint and produce weld flash. The weld flash ground on the right and left sides, and a fluid is applied to the weld joint during the grinding of the weld flash.

The fluid may be a compressed gas applied with a consistent flow rate.

The blade backer may be made of a carbon alloy steel.

The weld joint may be normalized after welding.

The weld joined ends may be annealed after welding.

Various aspects will become apparent to those skilled in the art from the following detailed description and the accompanying drawings.

### BRIEF DESCRIPTION OF THE DRAWINGS

FIG. 1A is a pictorial perspective view of a grinding setup.

FIG. 1B is a pictorial perspective view showing the installation of the grinding wheel into the grinding setup of FIG. 1A.

FIG. 1C is a closeup front view of the weld joint to be ground in the grinding setup of FIG. 1A.

FIG. 1D is schematic process representation of portions of a method for joining the ends of a blade backer to form a band saw blade.

FIG. 2A is a pictorial perspective view of the fluid application nozzle installed in the grinding setup of FIG. 1A.

FIG. 2B is a bottom perspective view of the nozzle of FIG. 2A.

FIG. 3A is a close-up image representation of the weld flash before grinding in the grinding setup of FIG. 1A.

FIG. 3B is a close-up image representation of the work piece of FIG. 3A after grinding in the grinding setup of FIG. 1A.

FIG. 4A is a close-up image representation of a workpiece ground dry in the grinding setup of FIG. 1A post bend test.

FIG. 4B is a close-up image representation of a workpiece ground in the grinding setup of FIG. 1A with fluid application of atmospheric air post bend test.

FIG. 4C is a close-up image representation of a workpiece ground in the grinding setup of FIG. 1A with fluid application of lubricant post bend test.

FIG. 4D is a close-up image representation of a workpiece ground in the grinding setup of FIG. 1A with fluid application of coolant post bend test.

FIG. 5 is a graph showing the resultant surface roughness data for all four workpieces of FIGS. 4A-4D.

FIG. 6 is a graph showing the resultant residual stress profiles of workpieces raw, normalize, and after dry grinding.

FIG. 7 is a graph showing the resultant residual stress profiles of workpieces ground dry, with lubricant, with coolant, and with atmospheric air.

FIG. 8A is a graph showing the microhardness data along the sub-surface of the ground surface for workpieces ground dry, with lubricant, with coolant, and with atmospheric air.

FIG. 8B is a visual representation of the sub-surface depth of the data points for the graph of FIG. 8A.

FIG. 9A is a surface image representation of a new unused grinding wheel.

FIG. 9B is a schematic diagram of the grinding wheel of FIG. 9A showing the location of the surface image.

FIG. 9C is a surface image representation similar to FIG. 9a except for a grinding wheel used in dry conditions after eight grinds.

FIG. 9D is a surface image representation similar to Fig. FIG. 9C is a surface image representation similar to FIG. 9a except for a grinding wheel used in conditions with lubricant after eight grinds.

FIG. 9E is a surface image representation similar to FIG. 9a except for a grinding wheel used in conditions with coolant after eight grinds.

FIG. 9F is a surface image representation similar to FIG. 9a except for a grinding wheel used in conditions with compressed gas after eight grinds.

FIG. 10 is a radial plot of surface integrity parameters for workpieces ground dry, with lubricant, with coolant, and with atmospheric air.

FIG. 11 is a table showing the parameters for the tests and methods described in some of the examples herein.

### DETAILED DESCRIPTION

The effect of the grinding process for weld flash removal on the surface integrity of the welded joint had not been researched. The surface integrity of the welded joint is essential for certain applications, for example bandsaw blades. One concern is premature failure at the weld joint due to fatigue loading (e.g., a band saw blade undergoes mainly cyclic bending fatigue during its service). It has been discovered that it is advantageous to apply fluid to weld joints during the grinding removal of weld flash.

The following are examples of using different fluid combinations on the grinding of weld flash, in particular on items of medium carbon alloy steel. This includes the use of compressed gas, in particular atmospheric air, but the use of other gases is also contemplated, such as inert gases, e.g., the noble gases, or low volatility gases, e.g., nitrogen or carbon dioxide. In addition to use of compressed gas, the examples below also include the use of lubricant, and coolant, and include dry grinding as a control example. The example for lubricant includes the application of minimum quantity lubricant using vegetable oil, and the example of coolant includes the application of minimum quantity coolant and used water-soluble oil. The surface roughness, sub-surface residual stresses, and microhardness of the ground regions were measured and will be further discussed below. The results show that the surface integrity of the welded joint is significantly influenced by the fluid application used during the grinding process of the flash. Dry grinding, the current industry standard for grinding weld flash, particularly in band saw blades, produced surface tensile residual stresses (24.82 MPa), lowest sub-surface microhardness (43.28 HRc), and the highest surface roughness (3.40 μm). In comparison, the atmospheric air application had the highest surface compressive residual stresses (−289.57 MPa), highest sub-surface microhardness (48.67 HRc), and relatively low surface roughness (1.61 μm).

For example of a metal working process, some of the final process steps in making a bandsaw blade include cutting a coil to a specific length and to weld the ends of the blade to form a continuous loop. The ends are welded with resistance welding, which is particularly preferred for joining alloyed steels to manufacture band saw blades. Such welding is, for example, also applicable for use in many other industrial applications, such as in railway and power distribution (e.g., electrical—bus bars). In the resistance welding process, the excess metal is extruded to the top of the weld joint, and the excess metal is called “flash”. The flash is removed using a machining process like grinding. In one operation, the grinding of the flash is carried out under circumstance without fluid application (i.e., dry). The grinding is intended to remove the weld-flash without inducing crack-like discontinuities along with the ground weld interface and to maintain the surface integrity of the welded joint. The weld joint(s) may be post processed to improve the structural integrity and service life. Such post processing methods include heat treatment, weld geometry machining, thermal relief, shot peening. Some weld applications require weld geometry or flash removal either by grinding or water jet eroding. Such weld geometry removal processes can induce tensile surface residual stresses. In one operation, a coolant is used in the grinding process to reduce the thermal effect on the ground surface. In one example, fluid may be applied according to minimum quantity fluid operations.

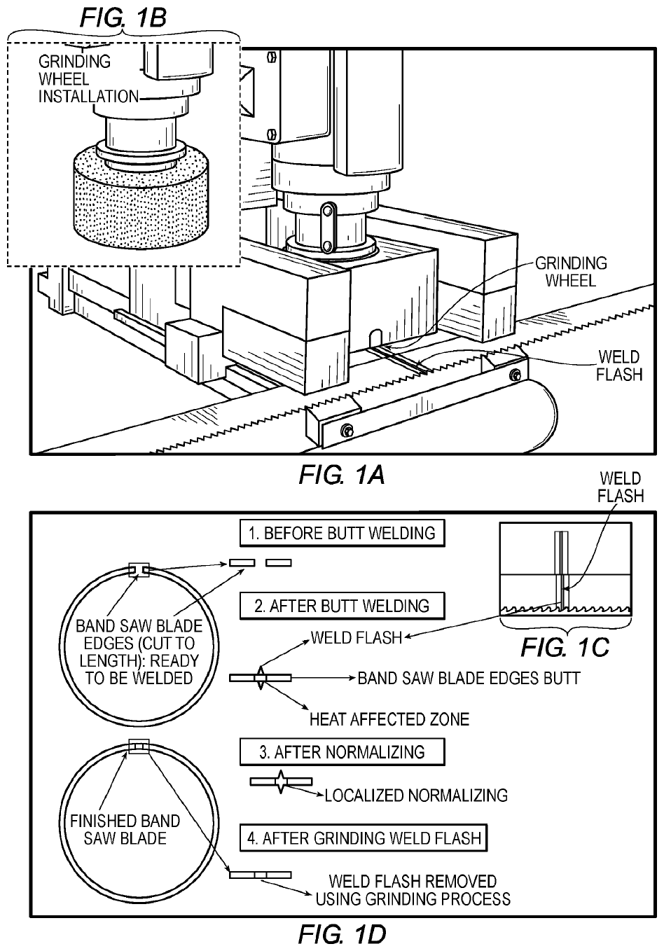

Referring now to the drawings, there is illustrated in FIG. 1D, some of the final steps for manufacturing a bandsaw blade. These steps include 1. cutting the stock material for the band saw blade to the length, 2. butt welding the end edges of the material using resistance welding, 3. normalizing the weld area, and 4. grinding the weld flash, as will be further described below.

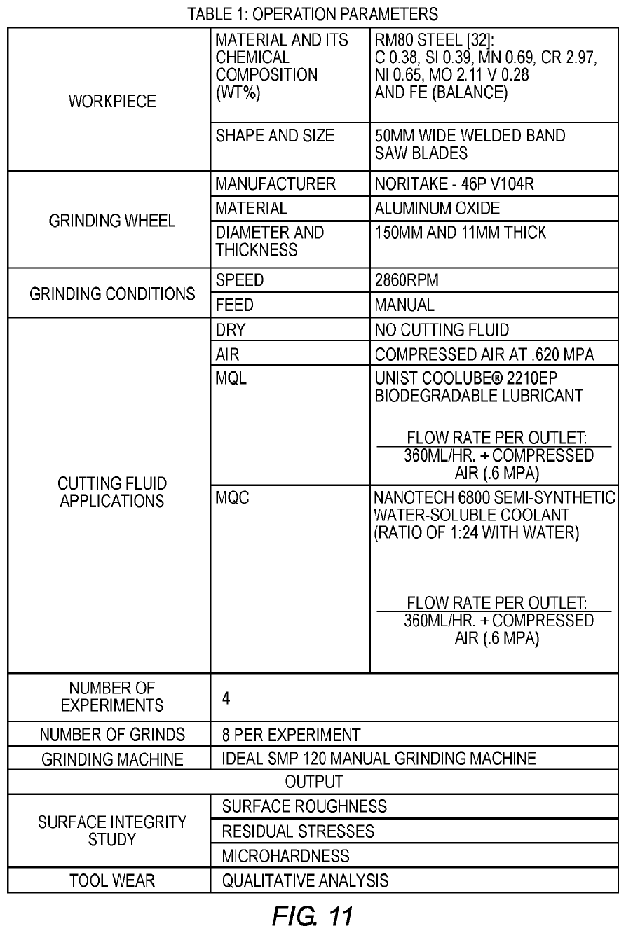

In general, the processes described below relate to 50 mm wide welded band saw blades −750 mm long. The band saw blades being made of medium carbon alloy steel. The blades were welded and normalized using an Ideal BAS340S welder. All data disclosed below are from band saw blades that were cut from the same manufacturing coil. The welded and normalized blades were ground using an Ideal SMP120 manual grinding machine at four different fluid conditions, namely dry, Compressed (Atmospheric) Air (CA), Minimum Quantity Lubricant (MQL), and Minimum Quantity Coolant (MQC). The weld flash heights were between 2.97 mm to 3.1 mm per side. The depth of weld flash removal for each pass was kept constant at 0.20 mm. FIG. 1A shows the setup of the grinding machine used for this work, with FIG. 1B showing the installation of the grinding wheel, and FIG. 1C showing a weld joint with weld flash. A table of operating parameters is shown in FIG. 11.

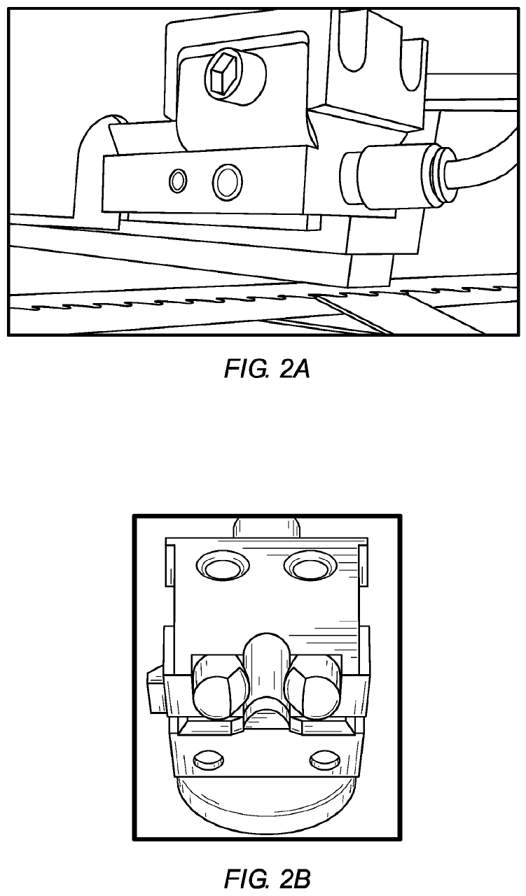

The Ideal SMP120 grinding machine is not equipped with any fluid delivery system. As best shown in FIGS. 2A and 2B, a UNIST Saw Blade Lube System™ (FIG. 2B) was installed on the grinding machine (FIG. 2A). The nozzle is directed towards the interface between the grinding wheel and the welded workpiece, in the present example, a band saw blade.

UNIST Coolube® 2210EP biodegradable lubricant was used as the lubricant for MQL application. Nanotech 6800 semi-synthetic water-soluble coolant mixed with water at the ratio of 1:24 was used for MQC application. The flow rate was constant for both MQL and MQC applications at 360 ml/hr. In air condition, compressed air at a pressure of 0.620 MPa was applied using the same outlet used for minimum quantity application.

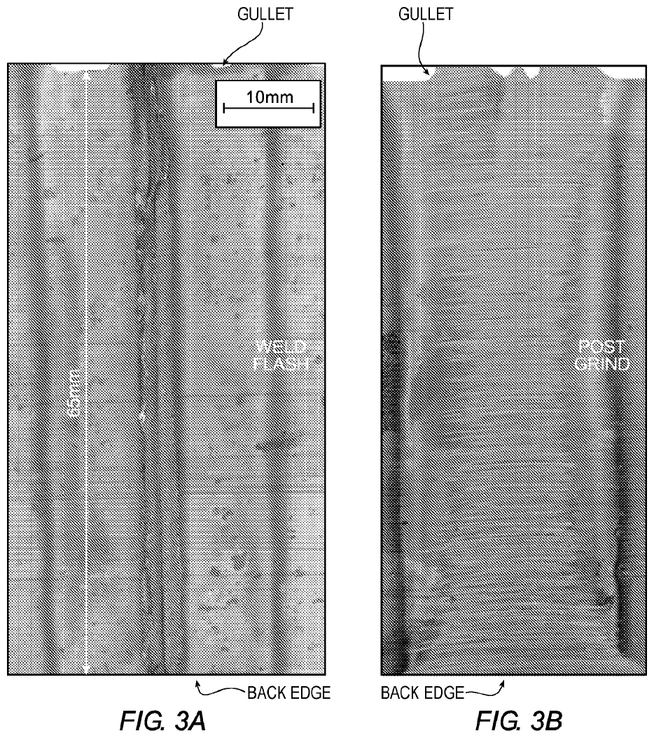

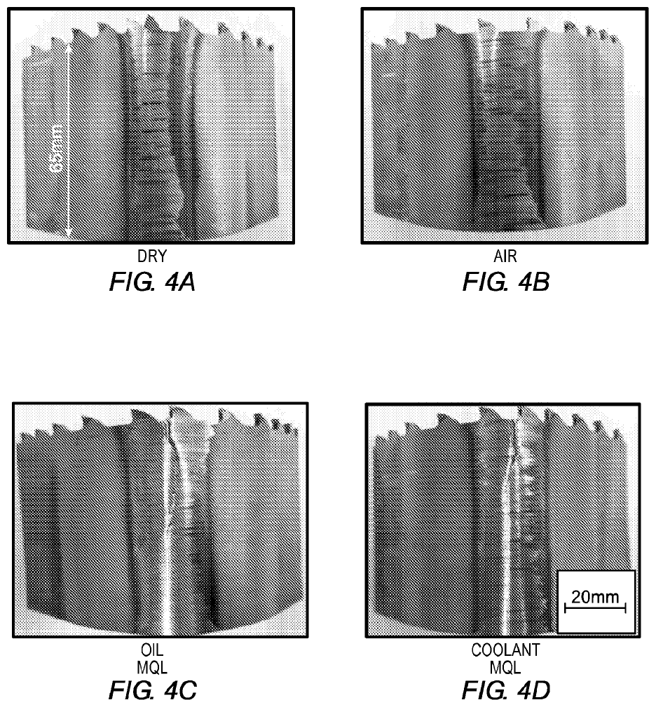

FIG. 3A shows the weld flash of a band saw blade pre-grind and FIG. 3B shows the same band saw blade post-grind. For the data discussed below, four welded and ground saw blades were manufactured for each grinding condition. Every saw blade had a weld flash on both sides after welding before grinding. Thus, a total of eight weld flashes were ground for each condition. In the grinding of weld flash operation, the grinding wheel moves across the weld flash. Subsequent, a bend test was performed to evaluate the weld strength. The bend test was carried out on a custom-built destructive bend tester in accordance with a standard testing method—ASTM E290-97a. FIGS. 4A-4D show images of post bend test samples for each of the four conditions.

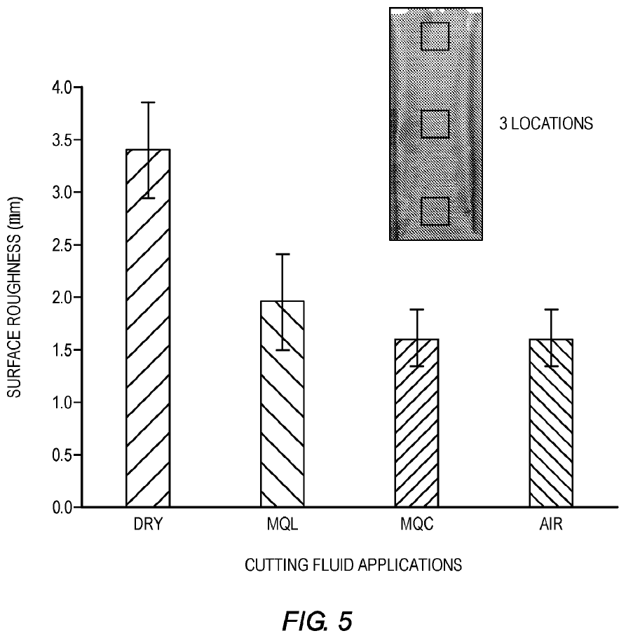

As will be further discussed below, Surface roughness, residual stresses, and microhardness were measured. Surface roughness was measured at three different spots (see FIG. 5)—close to the gullet, middle of the band, and close to the back edge (refer to FIGS. 3A and 3B) using a Keyence VHX 700 3D digital 4K optical microscope at ×1500 magnification. Additional techniques to measure residual stresses are X-ray diffraction and hole drilling methods, which both produce similar residual stress profiles. The hole drilling strain gage method was used to measure the residual stresses in the middle of the grind samples for all four conditions. The procedure that was utilized to measure the residual stresses using the hole drilling method was in accordance with a standard testing method—ASTM E837. Hole drilling method was used on EA-06-062RE-120/LE strain gages which were mounted on the samples to measure residual strains. Subsequent, H-Drill® software was used to calculate the surface residual stresses.

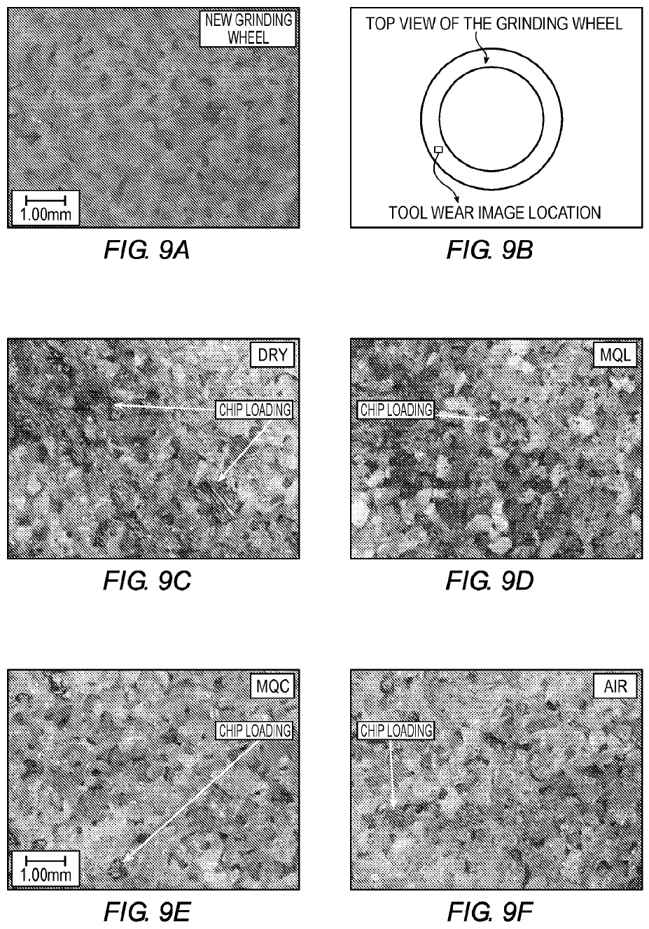

Microhardness was measured along the sub-surface of the ground workpieces using a Shimadzu HMV-2T E microhardness tester. The workpieces were cut relatively close to the back edge of the ground areas, with three readings at 25 μm, 50 μm, and 75 μm from the ground surface measured. Generally, for band saw blades, the area close to the back edge has the highest potential for thermal damage due to grinding as there is a direction change in the grinding process. A new grinding wheel was used for each workpiece (totaling use of eight grinds). Images of the used grinding wheels were taken at ×30 magnification using Keyence VHX 700 3D digital 4K optical microscope, see FIGS. 9A-9F. Again, Table 1 in FIG. 11 shows the complete operational plan for work.

Workpieces from all four conditions were tested using the custom-built bend tester to evaluate the weld quality. The bend test was conducted as per ASTM E290-97a [18]. FIGS. 4A-4D show the post bend test images of a workpiece from each of the four applications. MQL and MQC had cracks from the gullet due to improper removal of weld flash along the gullet. As best shown in FIGS. 3A and 3B, the gullet is the area between two teeth. The weld flash in the gullet area is removed using a different process. The welds of all four pieces passed the destructive bend test, showing that the weld quality was acceptable.

FIG. 5 shows the surface roughness data for all four grinding conditions, including fluid applications. Surface roughness was measured at three different locations along the ground surface, as shown in FIG. 5. As mentioned above, the surface roughness was measured using an optical microscope. The error bar in the graph represents one standard deviation. From the graph, it is evident that dry has the highest surface roughness among all four conditions. The surface roughness data for MQL, MQC, and air were relatively similar, showing the significance of cooling and/or lubricating while stock removal grinding of weld flash. It is believed that the improved surface roughness values due to the usage of the fluids (air, MQL, and MQC) can be attributed to the reduction in grinding temperatures, thus reducing the thermal damage. It is believed that the high grinding temperature can cause smearing leading to the loading of the grinding wheel. It is further believed that usage of the fluid improves the frictional interface along the chip and tool rake face, thus assisting chip flow and improving the surface roughness. Similar results were seen when using flood coolant versus dry slot grinding. Even though the lubrication and temperature effects of air, MQL, and MQC were different, the surface roughness values are statistically similar. Overall, the fluid applications (Air, MQL, and MQC) statistically improved the surface roughness values compared to dry grinding.

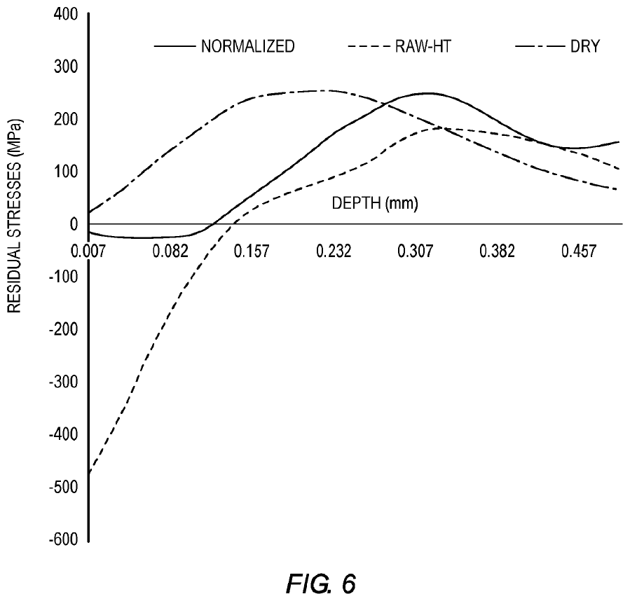

Residual stresses for all the ground workpieces were measured precisely at the same radial distance from the center of the workpiece. FIG. 6 shows the residual stress profiles along the sub-surface of the medium carbon alloy steel at different steps of a typical band saw manufacturing process. The incoming band saw material (Raw-HT) to the welding stage has a very high compressive surface residual stress due to the Heat Treatment (HT) and blasting process. The next step in the process is welding and normalizing the material. The sub-surface residual stresses of the normalized material were close to zero (up to −0.100 mm from the top surface). The next step is grinding the weld flash, in one example in dry condition (no fluid). The sub-surface residual stress profile for the dry condition was tensile in nature, without having any cross-over to compressive residual stress for the measured depth. The residual stress profile of the dry grinding process of an annealed weld shows that the dry grinding process has induced tensile sub-surface residual stresses along with the measured depth. It is believed that this could be attributed to the high grinding temperatures.

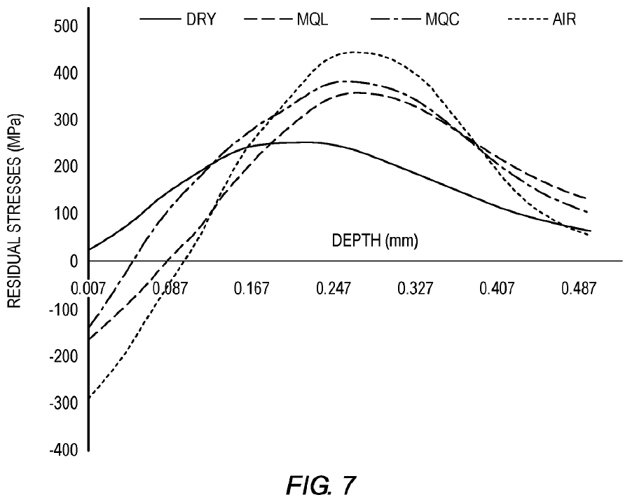

FIG. 7 shows the residual stress profile along the sub-surface of the ground surface for all four grinding conditions. Air produced the highest compressive sub-surface residual stress among the four conditions, while dry was the only condition with tensile sub-surface residual stresses. Tensile residual stresses are attributed to thermal loads, whereas compressive residual stresses are attributed to mechanical loads. Also, a similar trend was observed in other machining processes like facing steels and titanium with targeted minimum quantity fluid application. It is believed that grinding in dry condition produced a high temperature, thereby resulting in tensile sub-surface residual stresses, whereas, in the other three conditions, the mechanical effect is more dominant. Using minimum quantity fluid in this application improved the sub-surface integrity of the weld, thereby increasing the possibility of improved fatigue life of the weld.

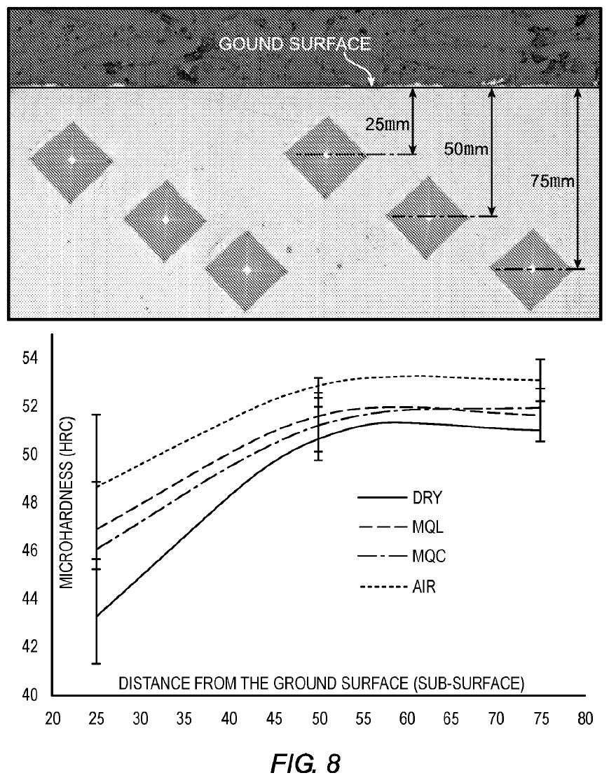

FIG. 8 shows microhardness along the sub-surface of the ground surfaces for all four conditions. It is believed that as the grinding wheels are designed to be thermally insulated, the grinding temperatures are transferred to the ground sub-surface causing thermal softening, and that thermal damage during the grinding of hardened steel results in the tempering of steel, leading to thermal softening. It is believed that this phenomenon occurring in all four conditions had lower sub-surface hardness than the bulk hardness. Dry had the lowest sub-surface microhardness suggesting that there could be severe thermal damage/thermal softening. Air had the highest sub-surface hardness suggesting that the condition had the least thermal damage. With dry condition, the grinding temperatures are higher than the fluid conditions as discussed above, thus leading to lower sub-surface hardness. Contrastingly, compressed air application reduced the grinding temperatures, thus reducing the thermal softening effect. Also, it is believed that the fluids could improve the frictional properties along the tool-chip interface, thereby reducing the grinding temperatures further.

FIGS. 9A-9F show a new unused grinding wheel (FIG. 9A), a diagram of the location of images (FIG. 9B) and used grinding wheel images for all four cutting fluid applications (FIGS. 9C-9F). Loading is visible on all four grinding wheels (as indicated in FIGS. 9c-9F). It is evident that the amount of loading in the dry condition is considerably higher than the other three applications. Thus, confirming that the temperature is relatively higher in dry condition, leading to increased loading and causing thermal softening. It is believed that loading of the grinding could negatively influence the grinding process, leading to premature tool wear, thermal surface damage, and increased grinding forces. It is believed that these factors could influence the surface roughness, as shown in FIG. 5. Air, MQL, and MQC also used an air jet, thus reducing this adhesion tendency by increasing the formation of interfacial/oxide films. Air, MQL, and MQC applications had relatively similar loading, suggesting a similar temperature range. As discussed above, it is believed that the fluid applications have the ability to improve the frictional properties and reduce the grinding wheel damage. An interesting observation is that the MQL grinding wheel had oil residue, as shown in FIG. 9. With the grinding wheel images and surface integrity studies, a tool wear study is recommended to extend this paper's hypothesis that using sustainable cutting solutions like MQL, MQC, or air will reduce the grinding temperature and reduce loading/tool wear.

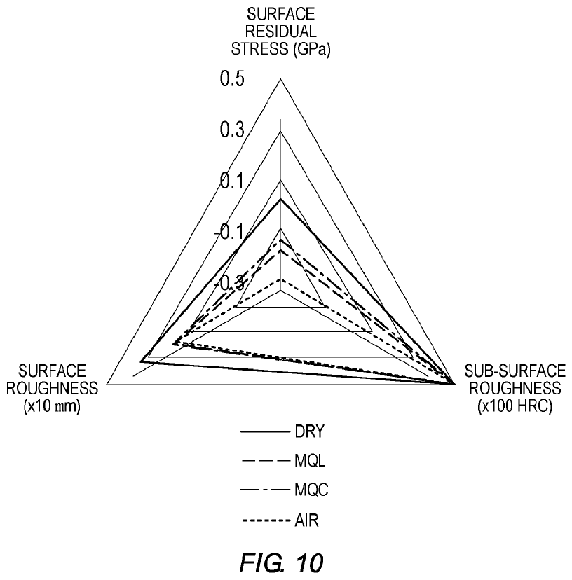

FIG. 10 shows a radial plot of the three surface integrity parameters discussed above (surface roughness, sub-surface hardness, and residual stresses). Based on the radial plot, air application had the highest surface compressive residual stresses, highest sub-surface microhardness, and relatively low surface roughness. Air has reduced the grinding temperatures, thereby reducing thermal damage. MQL and MQC are relatively similar, producing compressive sub-surface residual stresses and lower surface roughness values. Based on the observations, it is believed that MQC and MQL had reduced temperatures compared to dry condition.

As discussed above, the surface integrity of the welded joint is critical for the over life of a workpiece and to prevent any premature failure at the weld joint due to fatigue loading. It has been found to beneficial to use fluid application on the grinding of weld flash, especially with alloy steel. Results from the surface roughness, sub-surface residual stresses, and microhardness have shown that compressed (atmospheric) air produced superior surface integrity, that is, compressive sub-surface integrity, lower surface roughness, and less thermal damaged sub-surface, as compared to dry grinding.

While principles and modes of operation have been explained and illustrated with regard to particular embodiments, it must be understood, however, that this may be practiced otherwise than as specifically explained and illustrated without departing from its spirit or scope.

What is claimed is:

1. A method of forming a unitary metal piece comprising:
providing first and second generally planar metallic portions each having generally parallel first and second sides opposite each other, and each having an end edge extending between the first and second sides, where the first and second ends are proximate one another;
resistance welding the end edges together to form a weld joint and produce weld flash on at least one of the first and second sides of the portions;
grinding the weld flash on at least one of the first and second sides; and
applying a fluid to the weld joint during the grinding of the weld flash.

2. The method of claim 1 where the fluid is compressed gas.

3. The method of claim 2 where the compressed gas is one of atmospheric air, nitrogen, and carbon dioxide.

4. The method of claim 1 where the fluid is a lubricant applied according to Minimum Quantity Lubrication.

5. The method of claim 1 where the fluid is coolant applied according to Minimum Quantity Cooling Lubrication.

6. The method of claim 5 where the coolant is a semi-synthetic water-soluble coolant mixed with water.

7. The method of claim 1 where the fluid is applied with a consistent flow rate.

8. The method of claim 1 further comprising, prior to grinding, normalizing the weld joint.

9. The method of claim 1 further comprising, after welding, annealing the welded first and second portions.

10. The method of claim 1 where there is a crack or opening disposed between the ends of the first and second portions, and the method further comprises:
placing weldable material in the crack or opening prior to the welding.

11. The method of claim 10 where first and second portions are made of a carbon alloy steel.

12. The method of claim 1 where there is a crack or opening disposed between the ends of the first and second portions, and welding includes additively printing new material in the crack or opening to close the crack or the opening and joining the ends together to form a continuous body and where the weld flash is produced as additively printed weld flash on at least one of the first and second sides.

13. The method of claim 12 where first and second portions are made of a carbon alloy steel.

14. The method of claim 1 where first and second portions are made of a carbon alloy steel.

15. The method of claim 1 where the first and second portions are opposite ends of a generally planar blade backer.

16. A method of forming a band saw blade comprising:
providing a generally planar blade backer having generally parallel right and left sides opposite each other, and having first and second ends opposite each other, and having top and bottom edges opposite each other and extending between the right and left sides and extending between the first and second ends;
forming a plurality of teeth on the top edge of the blade backer;
abutting the first and second ends;
resistance welding the first and second ends together to form a weld joint and produce weld flash;
grinding the weld flash on the right and left sides; and
applying a fluid to the weld joint during the grinding of the weld flash.

17. The method of claim 16 where the fluid is a compressed gas applied with a consistent flow rate.

18. The method of claim 17 where the blade backer is made of a carbon alloy steel.

19. The method of claim 18 where one of the weld joint is normalized after welding or the weld joined ends are annealed after welding.

20. A method of forming a unitary metal piece comprising:
providing first and second generally planar portions of a metallic body having a crack or an opening in a body disposed between first and second ends of the portions;
additively printing material in the crack or the opening to close the crack or the opening and join the portions together to form a continuous body and produce additively printed weld flash;
grinding the additively printed weld flash; and
applying a fluid to the additively printed material during the grinding of the additively printed weld flash.
